(19) United States
(12) Patent Application Publication
(10) Pub. No.: US 2014/0044870 A1
(43) Pub. Date: Feb. 13, 2014

(54) MANUFACTURING METHOD OF LONG-SIZED CIRCULARLY POLARIZING PLATE

(71) Applicants: Yoshiaki Asanoi, Ibaraki-shi (JP); Shoichi Matsuda, Ibaraki-shi (JP); Tadayuki Kameyama, Ibaraki-shi (JP)

(72) Inventors: Yoshiaki Asanoi, Ibaraki-shi (JP); Shoichi Matsuda, Ibaraki-shi (JP); Tadayuki Kameyama, Ibaraki-shi (JP)

(73) Assignee: NITTO DENKO CORPORATION, Ibaraki-shi, Osaka (JP)

(21) Appl. No.: 13/811,845

(22) PCT Filed: Apr. 20, 2012
(86) PCT No.: PCT/JP2012/060679

§ 371 Date: Mar. 21, 2013

(30) Foreign Application Priority Data
Apr. 22, 2011 (JP) 2011-095674

(51) Int. Cl. G02B 5/30

(52) U.S. Cl. CPC G02B 5/3016
USPC 427/163.1

(57) ABSTRACT

A long-sized circularly polarizing plate consisting of long-sized retardation film having slow axis in one of in-plane directions and long-sized polarizing film having absorption axis in one direction within range of 25° to 65° with reference to the slow axis is manufactured through steps of: step A for applying rubbing treatment to the retardation film being conveyed, in such a manner that bottom surface of the retardation film is supported with first guide roll and second guide rolled arranged further downstream of the first guide roll along conveying direction of the retardation film while top surface thereof is pushed with rubbing roll between the first guide roll and the second guide roll; and step B for forming the polarizing film by applying liquid crystalline solution containing dichroic material to the top surface of the retardation film subjected to the rubbing treatment at step A and aligning the dichroic material there.

### TECHNICAL FIELD

The present invention relates to a manufacturing method of a long-sized circularly polarizing plate consisting of a long-sized retardation film and a long-sized polarizing film.

### BACKGROUND ART

As disclosed in JP Laid-open Patent Application Publication No. 2002-22944, there has conventionally been proposed a manufacturing method of a long-sized circularly polarizing plate, wherein adhesive agent is used so as to laminate together a long-sized retardation film made of a polymer film stretched in an oblique direction and a long-sized polarizing film made of a dichroic-material polymer film stretched in a longitudinal direction. The use of rollers contributes to continuous manufacturing of the above mentioned circularly polarizing plate and therefore, productivity thereof is excellent.
Patent Document 1: JP Laid-open Patent Application Publication No. 2002-22944

### DISCLOSURE OF THE INVENTION

### Problem to be Solved by the Invention

In the manufacturing method of a long-sized circularly polarizing plate disclosed in the Patent Document 1, when laminating the long-sized retardation film and the long-sized polarizing film, it is essential to paste them together with adhesive agent. The conventional manufacturing method requires a process to apply adhesive agent uniformly to either the long-sized retardation film or the long-sized polarizing film, which can possibly cause troubles in the course of continuous manufacturing of the long-sized circularly polarizing plate.

The present invention has been made to resolve the above-described conventional problem and the object of the present invention is to provide a manufacturing method of a long-sized circularly polarizing plate excellent in continuous productivity wherein a long-sized retardation film and a long-sized polarizing film can be laminated continuously without using adhesive agent.

### Means for Solving the Problem

To achieve the above object, the present invention according to claim 1 provides a manufacturing method of a long-sized circularly polarizing plate that consists of: a long-sized retardation film having slow axis in one of in-plane directions; and a long-sized polarizing film having absorption axis in one direction within a range of 25° to 65° with reference to a direction corresponding to the slow axis of the long-sized retardation film, the manufacturing method comprising steps of: step A for applying rubbing treatment to the retardation film which is being conveyed, in such a manner that a bottom surface of the long-sized retardation film is supported with a first guide roll and a second guide roll arranged further downstream of the first guide roll along a conveying direction of the long-sized retardation film while a top surface thereof is pushed with a rubbing roll between the first guide roll and the second guide roll; and a step B for forming the long-sized polarizing film by applying liquid crystalline solution containing dichroic material to the top surface of the long-sized retardation film subjected to the rubbing treatment at the step A and aligning the dichroic material there.

In the manufacturing method of a long-sized circularly polarizing plate of claim 2 according to claim 1, thickness of the long-sized retardation film is between 10 μm and 45 μm.

In the manufacturing method of a long-sized circularly polarizing plate of claim 3 according to claim 1 or 2, the long-sized retardation film is made of polyester resin, cellulose resin, cycloolefin resin or acrylic resin.

In the manufacturing method of a long-sized circularly polarizing plate of claim 4 according to any of claims 1 through 3, the liquid crystalline solution is a lyotropic liquid crystalline compound.

In the manufacturing method of a long-sized circularly polarizing plate of claim 5 according to any of claims 1 through 4, concentration of dichroic material in the long-sized polarizing film is between 80 and 100 weight percent with reference to overall weight of the long-sized polarizing film.

In the manufacturing method of a long-sized circularly polarizing plate of claim 6 according to any of claims 1 through 5, thickness of the long-sized polarizing film is between 0.1 μm and 5 μm.

In the manufacturing method of a long-sized circularly polarizing plate of claim 7 according to any of claims 1 through 6, thickness of the long-sized circularly polarizing plate is 50 μm or thinner.

In the manufacturing method of a long-sized circularly polarizing plate of claim 8 according to any of claims 1 through 7, thickness of the long-sized circularly polarizing plate is between 20 μm and 40 μm.

### Effect of the Invention

In the manufacturing method of a long-sized circularly polarizing plate according to the present invention, at the step A, while the long-sized retardation film is being conveyed with the bottom surface thereof being supported by the first guide roll and the second guide roll, the top surface thereof is pushed with the rubbing roll so as to apply a rubbing treatment thereon. At the step B, the long-sized polarizing film is formed in such a manner that the liquid crystalline solution containing dichroic material is applied to the top surface of the long-sized retardation film subjected to the rubbing treatment at the step A while the dichroic material is aligned. The above such steps A and B allow continuous lamination of the long-sized retardation film and the long-sized polarizing film without using adhesive agent. Thereby, a superior long-sized circularly polarizing plate can be manufactured through the manufacturing method thereof excellent in continuous productivity.

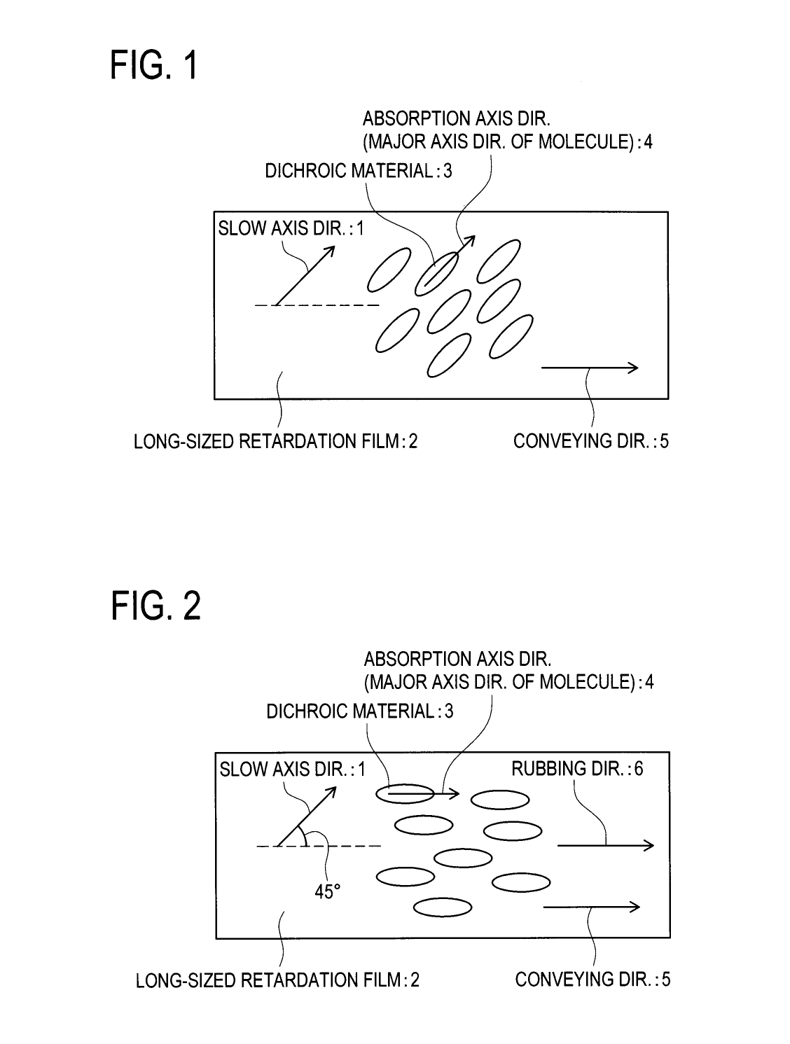

With respect to the manufacturing method of a long-sized circularly polarizing plate according to the present invention, the mechanism to realize the above mentioned working effect will be described by referring to FIG. 1 and FIG. 2. FIG. 1 is a schematic view for illustrating relation between a slow axis direction of a retardation film and an alignment direction of dichroic material in a case of manufacturing a circularly polarizing plate by applying liquid crystalline solution containing dichroic material to the retardation film in accordance with a conventional manufacturing method thereof. FIG. 2 is a schematic view for illustrating relation between a slow axis direction of a retardation film and an alignment direction of dichroic material in a case of manufacturing a circularly polarizing plate by applying liquid crystalline solution containing dichroic material to the retardation film in accordance with the manufacturing method of the present invention.

It is generally feasible to form a polarizing film by applying a liquid crystalline solution containing dichroic material to a film surface thereof while the dichroic material applied to the film is aligned. Thus, it is considered feasible to form a polarizing film on a substrate film without using adhesive agent.

However, as shown in FIG. 1, in a case of forming a polarizing film by applying liquid crystalline solution containing dichroic material 3 to the top surface of the long-sized retardation film 2 having a slow axis direction 1 in one of the in-plane directions, the dichroic material 3 is likely to get aligned so that an absorption axis direction 4 (major axis direction of molecule) and the slow axis direction 1 of the retardation film 2 get parallel with each other. Although not shown, some kinds of dichroic material 3 may get aligned so that the major axis direction 4 of the dichroic material 3 gets perpendicular to the slow axis direction 1.

Therefore, the conventional method has met difficulties in aligning the absorption axis direction 4 of the dichroic material 3 in one direction within an arbitrary angular range, e.g., a range of 25° to 65° with reference to the slow axis direction 1 corresponding to one of in-plane directions of the retardation film 2.

Meanwhile, in the manufacturing method of a long-sized circularly polarizing plate directed to the present invention, as shown in FIG. 2, at the step A, the rubbing treatment is applied to the top surface of the long-sized retardation film 2 by the rubbing roll along the rubbing direction 6 that is in parallel with the conveying direction 5 while the long-sized retardation film 2 is being conveyed in the conveying direction 5. Therefore, the dichroic material 3 gets aligned so that the absorption axis direction 4 (major axis direction of molecular) of the dichroic material 3 gets parallel with the rubbing direction 6 (in the example of FIG. 2, the slow axis direction 1 and the rubbing direction 6 form a direction angle of approximately 45°). Although not shown, some kinds of dichroic material 3 may get aligned so that the absorption axis direction 4 gets perpendicular to the rubbing direction 6.

Specifically, between the two kinds of alignment property, namely, alignment property strength given to the dichroic material 3 through the rubbing treatment and alignment property strength given in the slow axis direction 1 of the long-sized retardation film 2, higher preference is put to the former one. Consequently, a direction angle to be formed by the delay axis direction 1 of the long-sized retardation film 2 and the rubbing direction 6 is set to a desired angle within a range of 25° to 65°, whereby there can be manufactured a long-sized circularly polarizing plate configured such that the absorption axis direction 4 of the dichroic material 3 contained in the polarizing film applied to the long-sized retardation film 2 is set to one direction within a range of 25° to 65° with reference to the slow axis direction 1 of the long-sized retardation film 2.

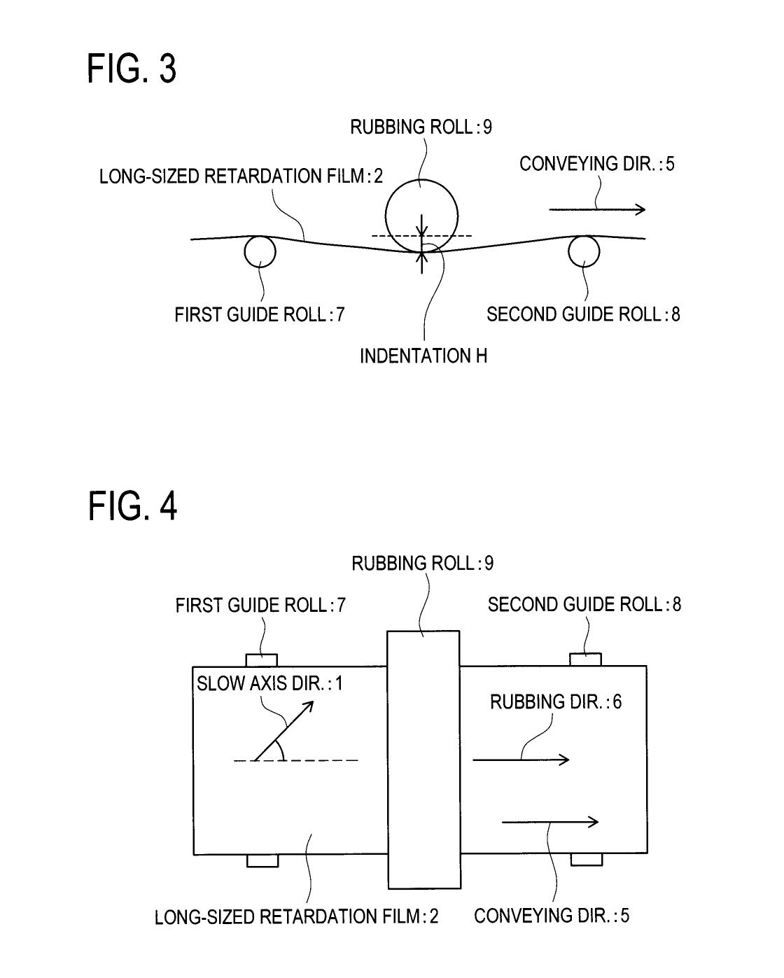

### BRIEF DESCRIPTION OF THE DRAWINGS

[FIG. 1] is a schematic view for illustrating relation between a slow axis direction of a retardation film and an alignment direction of dichroic material in a case of manufacturing a circularly polarizing plate by applying liquid crystalline solution containing dichroic material to the retardation film in accordance with a conventional manufacturing method thereof.

[FIG. 2] is a schematic view for illustrating relation between a slow axis direction of a retardation film and an alignment direction of dichroic material in a case of manufacturing a circularly polarizing plate by applying liquid crystalline solution containing dichroic material to the retardation film in accordance with the manufacturing method of the present invention.

[FIG. 3] is a schematic view for illustrating the manufacturing method of a long-sized circularly polarizing plate directed to the present embodiment when seen from cross section.

[FIG. 4] is a plane schematic view for illustrating the manufacturing method of a long-sized circularly polarizing plate directed to the present embodiment when seen from top.

### BEST MODE FOR CARRYING OUT THE INVENTION

Here will be described on an embodiment of a manufacturing method of a long-sized circularly polarizing plate directed to the present invention.

(1) Manufacturing Method of Long-sized Circularly Polarizing Plate Directed to Present Embodiment

A long-sized circularly polarizing plate of the present embodiment consists of a long-sized retardation film having slow axis in one of in-plane directions and a long-sized polarizing film having absorption axis in one direction within a range of 25° to 65° with reference to a direction corresponding to the slow axis of the long-sized retardation film. Thus configured long-sized circularly polarizing plate is manufactured through steps A and B to be described later. Arbitrary steps may be inserted between the step A and the step B.

(2) Step A

As shown in FIG. 3 and FIG. 4, a rubbing treatment is performed at the step A. More specifically, in a state that a long-sized retardation film 2 is conveyed with a bottom surface thereof being supported by a first guide roll 7 and a second guide roll 8 arranged further downstream of the first guide roll 7 along the conveying direction 5, a rubbing treatment is applied to a top surface thereof by pushing the top surface with a rubbing roll 9 between the first guide roll 7 and the second guide roll 8.

The above-described rubbing treatment is called tension-web-type rubbing treatment in the manufacturing industry of circularly polarizing plates and distinctive characteristic of this treatment lies in absence of a back roll at a position opposing to the rubbing roll 9. By practicing the rubbing treatment of this type, a superior long-sized circularly polarizing plate can be manufactured.

The above-mentioned guide rolls 7 and 8 serve to support the long-sized retardation film 2 that is conveyed while rolling in contact with a bottom surface of the long-sized retardation film 2. Although material and size of respective guide rolls 7 and 8 are not particularly limited, they are rubber or metallic rolls of which diameter is 10 mm to 500 mm. The first guide roll 7 and the second guide roll 8 may be made identical or may be made different.

The above mentioned rubbing treatment is to rub the top surface of the long-sized retardation film 2 with a rubbing cloth so as to align dichroic material 3 applied to the top surface when liquid crystalline solution containing the dichroic material 3 is applied to the top surface of the long-sized retardation film 2. The rubbing treatment is performed by using the rubbing roll on which a rubbing cloth with rising pile is wound, for instance; the top surface of the long-sized retardation film 2 being conveyed is pushed with the thus configured rubbing roll 9. Material of the rubbing cloth is not particularly limited; cotton, rayon and the like may be used, for instance. Arrangement angle of the rubbing roll 9 with reference to conveying direction of the long-sized retardation film 2 is properly set depending on use of the product. Further, indentation H (length for the rubbing roll 9 to push down the retardation film 2 with reference to the surface level of the film 2 before pushed down: refer to FIG. 3) is properly set so as to align the dichroic material 3 in rubbing treatment direction.

The indentation H is preferably 5 mm to 30 mm. With the above conditioned indentation H, alignment property working in the rubbing treatment direction 6 is made stronger than alignment property working in the slow axis direction 1 of the long-sized retardation film 2.

(3) Step B

At step B, a long-sized polarizing film is formed by applying liquid crystalline solution containing the dichroic material 3 to the top surface of the long-sized retardation film 2 subjected to the rubbing treatment at the step A and aligning the dichroic material 3 there.

The liquid crystalline solution typically contains the dichroic material 3 and solvent. The dichroic material is preferably a lyotropic liquid crystal compound. In the present embodiment, the lyotropic liquid crystal compound is refer to as compound that exhibits liquid crystalline characteristic when dissolved in a solvent medium. Favorable examples of lyotropic liquid crystalline compounds are an azo compound, an anthraquinone compound, a perylene compound, a quinophthalone compound, a naphthoquinone compound, a merocyanine compound and the like. Those compounds exhibit absorption dichroism in visible light region as well as excellent alignment property.

Favorable solvent are water, alcohols, ketones, cellosolves and mixtures of those. Concentration of the dichroic material 3 is preferably 2 to 30 weight percent with reference to overall weight of the liquid crystalline solution.

Any application methods of liquid crystalline solution are practicable as long as uniform flow casting of liquid crystalline solution can be exercised. For instance, a wire bar, a gap coater, a comma coater, a gravure coater, a slot die, and the like can be used. The liquid crystalline solution applied there may be dried spontaneously or by heating.

(4) Long-Sized Circularly Polarizing Plate

The long-sized circularly polarizing plate obtained through the manufacturing method directed to the present embodiment is configured to generate circularly polarized light in a certain wave length falling within the visible light region (wave length of 380 nm to 780 nm) when linear polarized light is emitted thereto from certain direction.

The long-sized circularly polarizing plate consists of the long-sized retardation film 2 having slow axis in one of in-plane directions (slow axis direction 1) and the long-sized polarizing film having absorption axis in one direction within a range of 25° to 65° with reference to the slow axis direction 1 (absorption axis direction 4). When positional relation between the slow axis direction 1 of the long-sized retardation film 2 and the absorption axis direction 4 of the long-sized polarizing film satisfies the above specified direction angle range, the long-sized circularly polarizing plate can convert natural light or linearly polarized light to circularly polarized light.

In the present embodiment, “long-sized” refers to length sufficiently longer than width, preferably, length longer than width by ten times or larger. Preferably, length of the long-sized circularly polarizing plate is 300 m or longer, overall thickness of the plate is 50 μm or thinner, more preferably, 20 μm to 40 μm.

The long-sized retardation film 2 has slow axis in one of in-plane directions (slow axis direction 1). Preferably, the slow axis direction 1 of the retardation film 2 declines by 25° to 65° with reference to longitudinal direction of the film. Given that refractive index in the slow axis direction 1 is nx, in-plane refractive index to intersect with nx in retardation film 2 is ny and refractive index in thickness direction is nz, those refractive indexes satisfy either one of relations: (nx>ny=nz) or (nx>ny>nz). Preferably, thickness of the long-sized retardation film 2 is between 10 μm and 45 μm. Although material is not particularly limited, the long-sized retardation film 2 is made of polyester resin, cellulose resin, cycloolefin resin, acrylic resin and the like.

The long-sized polarizing film exhibits absorption dichroism in a certain wave length falling within the visible light region and has absorption axis in one of in-plane directions (absorption axis direction 4). Absorption dichroism can be obtained by aligning the dichroic material 3 contained in the long-sized polarizing film. The absorption axis direction 4 of the long-sized polarizing film is parallel with or perpendicular to the longitudinal direction thereof (refer to FIG. 2). Preferably, concentration of the dichroic material 3 in the long-sized polarizing film is between 80 and 100 weight percent with reference to overall weight of the long-sized polarizing film. Preferably, thickness of the long-sized polarizing film is between 0.1 μm and 5 μm.

(5) Use of Long-Sized Circularly Polarizing Plate

The long-sized circularly polarizing plate thus obtained in the present embodiment is used for liquid crystal displays, organic electrolyte displays, for instance, and capable of achieving high contrast when used for large format displays.

### Embodiment

Rubbing treatment in similar with the method illustrated with FIG. 3 and FIG. 4 is applied to a surface of a long-sized retardation film 2 made of cycloolefin polymer film having slow axis in 45° direction (slow axis direction 1) with reference to the longitudinal direction thereof while the long-sized retardation film 2 is being conveyed. Next, liquid crystalline solution containing dichoic material 3 (prepared by dissolving an azo compound in water in accordance with embodiment 1 of JP Laid-open Patent Application Publication No. 2009-173849) is applied to the rubbing-treatment-applied surface of the long-sized retardation film 2 and dried spontaneously so as to obtain a long-sized polarizing film having thickness of 0.4 μm. Thus obtained long-sized circularly polarizing plate has overall thickness of 33 μm. Quality of the long-sized circularly polarizing plate is examined and no scratches are observed on the surface thereof.

Measurement Method Used in Embodiment

### (1) Measurement of Thickness

Thickness has been measured by using a digital gage (product name “PEACOCK”, product of Ozaki Mfg. Co., Ltd.).

### (2) Evaluation of Quality

A sample has been cut out from a long-sized circularly polarizing plate of the present embodiment and placed in visual observation wherein size of scratch caused in the course of rubbing treatment has been checked by properly turning the sample left and right under irradiation of white light source thereon.

### INDUSTRIAL APPLICABILITY

The present invention makes it possible to continuously laminate the long-sized retardation film and a long-sized polarizing film without using adhesive agent. Thereby, there can be realized the manufacturing method of a long-sized circularly polarizing plate excellent in continuous productivity; industrial contribution thereby is significant.

### EXPLANATION OF REFERENCES

1 slow axis direction
2 long-sized retardation film
3 dichroic material
4 absorption axis direction (major axis direction of molecule)
5 conveying direction
6 rubbing direction
7 first guide roll
8 second guide roll
9 rubbing roll

1. A manufacturing method of a long-sized circularly polarizing plate that consists of:
a long-sized retardation film having slow axis in one of in-plane directions; and
a long-sized polarizing film having absorption axis in one direction within a range of 25° to 65° with reference to a direction corresponding to the slow axis of the long-sized retardation film,
the manufacturing method comprising steps of:
step A for applying rubbing treatment to the retardation film which is being conveyed, in such a manner that a bottom surface of the long-sized retardation film is supported with a first guide roll and a second guide roll arranged further downstream of the first guide roll along a conveying direction of the long-sized retardation film while a top surface thereof is pushed with a rubbing roll between the first guide roll and the second guide roll; and
a step B for forming the long-sized polarizing film by applying liquid crystalline solution containing dichroic material to the top surface of the long-sized retardation film subjected to the rubbing treatment at the step A and aligning the dichroic material there.

2. The manufacturing method of a long-sized circularly polarizing plate according to claim 1, wherein thickness of the long-sized retardation film is between 10 μm and 45 μm.

3. The manufacturing method of a long-sized circularly polarizing plate according to claim 1, wherein the long-sized retardation film is made of polyester resin, cellulose resin, cycloolefin resin or acrylic resin.

4. The manufacturing method of a long-sized circularly polarizing plate according to claim 1, wherein the liquid crystalline solution is a lyotropic liquid crystalline compound.

5. The manufacturing method of a long-sized circularly polarizing plate according to claim 1, wherein concentration of the dichroic material in the long-sized polarizing film is between 80 and 100 weight percent with reference to overall weight of the long-sized polarizing film.

6. The manufacturing method of a long-sized circularly polarizing plate according to claim 1, wherein thickness of the long-sized polarizing film is between 0.1 μm and 5 μm.

7. The manufacturing method of a long-sized circularly polarizing plate according to claim 1, wherein thickness of the long-sized circularly polarizing plate is 50 μm or thinner.

8. The manufacturing method of a long-sized circularly polarizing plate according to claim 1, wherein thickness of the long-sized circularly polarizing plate is between 20 μm and 40 μm.
